(19) United States
(12) Patent Application Publication
(10) Pub. No.: US 2012/0278638 A1
(43) Pub. Date: Nov. 1, 2012

(54) ELECTRONIC DEVICE AND CONTROL METHOD

(75) Inventors: YIN-ZHAN WANG, Shenzhen City (CN); JUN ZHANG, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/331,386

(22) Filed: Dec. 20, 2011

(30) Foreign Application Priority Data
Apr. 28, 2011 (CN) 201110108135.6

(51) Int. Cl. G06F 1/32; G06F 1/16; G06F 1/00

(52) U.S. Cl. 713/320; 713/300; 361/679.02

(57) ABSTRACT

An electronic device includes a main body, a cover hinged on the main body, a first sensor arranged in the main body, a second sensor arranged in the cover, and a processor. The first sensor senses a change of displacement of the first sensor when the main body is moved to generate a first coordinate information. The second sensor senses a change of displacement of the second sensor when the cover is moved to generate a second coordinate information. The processor calculates an angle between the main body and the cover according to the first coordinate information and the second coordinate information, and controls the electronic device according to the calculated angle. A method for controlling an electronic device is also provided.

### BACKGROUND

1. Technical Field

The present disclosure relates to electronic devices and, more particularly, to a collapsible electronic device and a control method for the collapsible electronic device.

2. Description of Related Art

Portable electronic devices such as mobile phones, personal data assistants (PDA), hand-held computers, and notebook computers have been widely used due to convenience and practicality. Generally, the portable electronic devices need to be powered off or be put in a standby mode when not in use. A mechanical switch is typically provided to power off the portable electronic devices or to change the portable electronic devices to be in the standby mode. However, the mechanical switch can become worn and will be ineffective after being pressed many times.

Therefore, there is room for improvement in the art.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic view of an electronic device in accordance with an exemplary embodiment.

FIG. 2 is a block diagram of the electronic device of FIG. 1, in accordance with an exemplary embodiment.

FIG. 3 is a schematic view showing the electronic device of FIG. 1 rotated from an open state to a closed state.

FIG. 4 is a flowchart of a method for controlling the electronic device of FIG. 1, in accordance with an exemplary embodiment.

### DETAILED DESCRIPTION

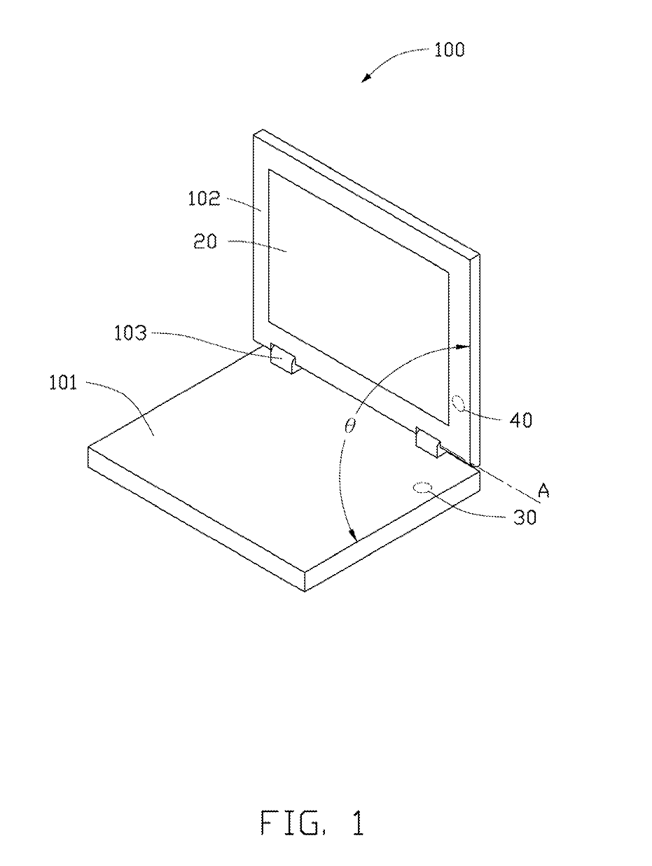

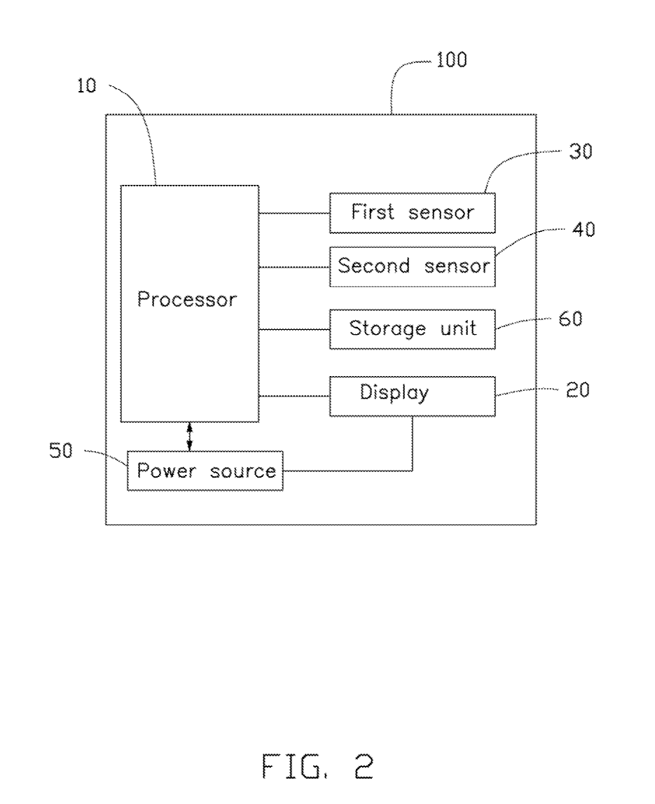

Referring to FIGS. 1-2, an embodiment of a collapsible electronic device 100 is illustrated. The electronic device 100 includes a main body 101 and a cover 102 hinged on the main body 101 with two hinges 103, whereby an angle θ between the main body 101 and the cover 102 (hereinafter, the angle θ) can be changed. The electronic device 100 may be a notebook computer, a mobile phone, for example. The main body 101 houses a processor 10, a first sensor 30, a power source 50, a storage unit 60, and other electronic elements (not shown). The cover 102 houses a display screen 20 and a second sensor 40. The power source 50 provides power to the electronic device 100. The storage unit 60 stores video files, audio files, image files, a predetermined angle range, for example. The display screen 20 displays visual information.

The first sensor 30 senses a change of displacement of the first sensor 30 when the main body 101 is moved to generate a first coordinate information. The second sensor 40 senses a change of displacement of the second sensor 40 when the cover 102 is moved to generate a second coordinate information. In this embodiment, the first sensor 30 and the second sensor 40 are three-axis sensors, such as three-axis accelerometers. The first coordinate information and the second coordinate information are coordinate information of three-dimensional space. The first sensor 30 and the second sensor 40 are arranged in a plane perpendicular to a line A joining the two hinges 103.

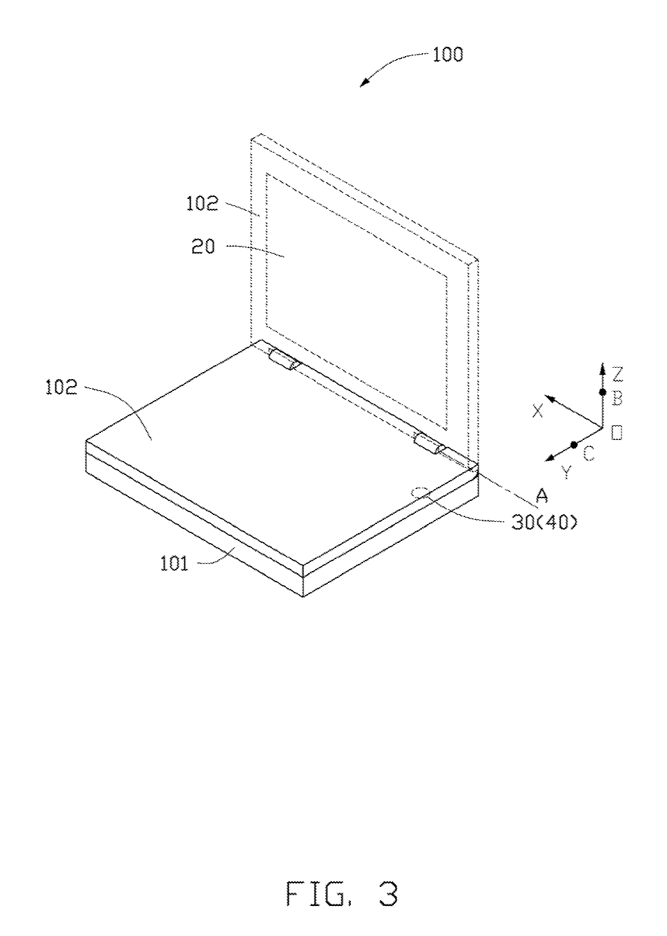

The processor 10 is electrically connected to the first sensor 30 and the second sensor 40. The processor 10 calculates the angle θ between the main body 101 and the cover 102 according to the first coordinate information generated by the first sensor 30, and the second coordinate information generated by the second sensor 40. In addition, the processor 10 controls the electronic device 100 to execute a predetermined function according to the calculated angle θ and a predetermined angle range. In this embodiment, if the angle θ falls within a predetermined angle range, the processor 10 controls the electronic device 100 to execute a corresponding function. For example, if the angle θ is less than 30 degrees, the processor 10 powers off the electronic device 100. If the angle θ falls with the range from 30 degrees to 60 degrees, the processor 10 changes the display 20 of the electronic device 100 to be in power-saving state. If the angle θ is greater than 60 degrees, the processor 10 plays an audio file. In this embodiment, the angle θ within the predetermined range includes that the angle θ is equal to the lower threshold of the predetermined range. As shown in FIG. 3, when the cover 102 is rotated from an open state where the cover 102 is substantially perpendicular to the main body 101 to a closed state where the cover 102 covers the main body 101. The angle θ between the main body 101 and the cover 102 is 0, which is less than 30 degrees, and the processor 10 powers off the electronic device 100.

Referring to FIG. 3, for better understanding of the present disclosure, an example is given to illustrate the present disclosure. In this example, the main body 101 is not moved, and only the cover 102 is rotated about the main body 101. A three-dimensional coordinate system with three coordinate axes perpendicular with each other is defined, where an O-X axis is parallel with the axis A of the hinges 103, an O-Y axis is parallel with the main body 101. An O-Z axis is perpendicular to the main body 101. When the cover 102 is rotated, the coordinate information of the second sensor 40 changes. As the main body 101 is not moved, the coordinate information of the first sensor 30 remains unchanged. The O-X axis is parallel to the axis A, thus the abscissa of the second sensor 40 remains unchanged. When the cover 102 is rotated about the main body 101, for example, from a position C (0, 2, 0) where the cover 102 covers the main body 101 to a position B (0, 0, 2). The second sensor 40 senses coordinate information of the positions B, C, and transmits the sensed coordinate information of the positions B, C to the processor 10. The processor 10 determines the distance between the positions B, C according to the formula |BC|=sqrt[(x2−x1)̂2+(y2−y1)̂2+(z2−z1)̂2)], where x1, y1, and z1 are the coordinate values of the position B, and x2, y2, and z2 are the coordinate values of the position C. In this example, |AB|=2\sqrt{2}. Thus, the angle θ can be calculated according to the formula θ=arccos([y2−y1)̂2+(z2−z1)̂2)−|BC|̂A2)[/2*(y2−y1)*(z2−z1)). In this embodiment, the angle θ is 90 degrees, which is greater than 60 degrees, and the processor 10 controls the electronic device 100 to play an audio file after the electronic device 100 is powered on.

Furthermore, the processor 10 can also detect work environment of the electronic device 100 according to the first coordinate information sensed by the first sensor 30 and the second coordinate information sensed by the second sensor 40. In addition, the processor 10 takes a protection action to protect the electronic device 100 if the processor 10 determines that the electronic device 100 encounters sudden changes in motion, for example, temporarily stops the hard drive to help protect valuable data from the shock of being dropped, for example.

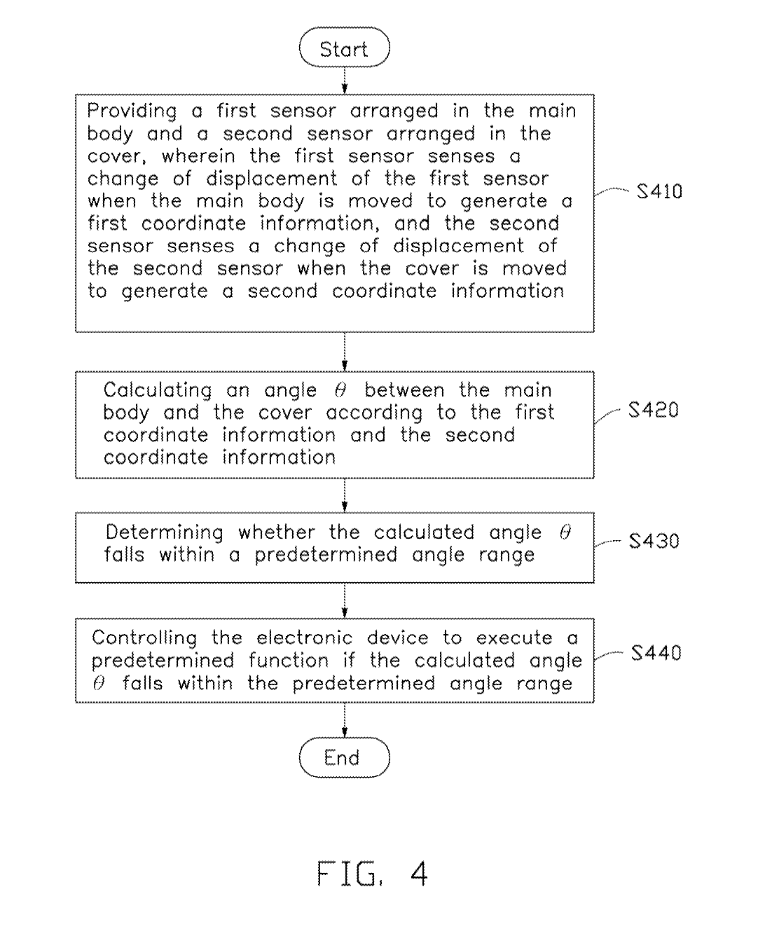

FIG. 4 is a flowchart of a method for controlling the electronic device 100, in accordance with an embodiment.

In step S410, the first sensor 30 senses a change of displacement of the first sensor 30 when the main body 101 is moved to generate a first coordinate information, and the second sensor 40 senses a change of displacement of the second sensor 40 when the cover 102 is moved to generate a second coordinate information.

In step S420, the processor 10 calculates an angle θ between the main body 101 and the cover 102 according to the first coordinate information generated by the first sensor 30 and the second coordinate information generated by the second sensor 40.

In step S430, the processor 10 determines whether the calculated angle θ falls within the predetermined angle range.

In step S440, the processor 10 controls the electronic device 100 to execute a predetermined function if the calculated angle θ falls within the predetermined angle range.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device comprising:
a main body;
a cover hinged on the main body;
a first sensor arranged in the main body, the first sensor sensing a change of displacement of the first sensor when the main body is moved to generate a first coordinate information;
a second sensor arranged in the cover, the second sensor sensing a change of displacement of the second sensor when the cover is moved to generate a second coordinate information; and
a processor calculating an angle between the main body and the cover according to the first coordinate information generated by the first sensor and the second coordinate information generated by the second sensor, and controlling the electronic device according to the calculated angle.

2. The electronic device as described in claim 1, wherein the processor determines whether the calculated angle falls within a predetermined angle range, and controls the electronic device to execute a predetermined function if the calculated angle falls within the predetermined angle range.

3. The electronic device as described in claim 2, wherein the predetermined function is to power off the electronic device.

4. The electronic device as described in claim 2, wherein the predetermined function is to change a display screen of the electronic device to be in a power-saving state.

5. The electronic device as described in claim 1, wherein the processor further determines whether the electronic device encounters sudden changes in motion according to the first coordinate information and the second coordinate information, and takes a protection action to protect the electronic device when the electronic device encounters sudden changes in motion.

6. The electronic device as described in claim 1, wherein the cover is rotatable around an axis A relative to the main body.

7. The electronic device as described in claim 6, wherein the first sensor and the second sensor are arranged in a plane perpendicular to the axis A.

8. The electronic device as described in claim 1, wherein the first sensor and the second sensor are three-axis accelerometers.

9. A method for controlling an electronic device, the electronic device comprising a main body, a cover hinged to the main body, the method comprising:
providing a first sensor arranged in the main body and a second sensor arranged in the cover, wherein the first sensor senses a change of displacement of the first sensor when the cover is moved to generate a first coordinate information, and the second sensor senses a change of displacement of the second sensor when the main body is moved to generate a second coordinate information;
calculating an angle between the main body and the cover according to the first coordinate information generated by the first sensor and the second coordinate information generated by the second sensor; and
controlling the electronic device according to the calculated angle.

10. The method as described in claim 9, wherein the step of controlling the electronic device according the calculated angle comprises:
determining whether the calculated angle falls within a predetermined angle range; and
controlling the electronic device to execute a predetermined function if the calculated angle falls within the predetermined angle range.

11. The method as described in claim 10, wherein the predetermined function is to power off the electronic device.

12. The method as described in claim 10, wherein the predetermined function is to change a display screen of the electronic device to be in a power-saving state.

13. The method as described in claim 10, further comprising:
determining whether the electronic device encounters sudden changes in motion according to the first coordinate information and the second coordinate information; and
taking a protection action to protect the electronic device when the electronic device encounters sudden changes in motion.

14. The method as described in claim 9, wherein the cover is rotatable around an axis A relative to the main body.

15. The method as described in claim 14, wherein the first sensor and the second sensor are arranged in a plane perpendicular to the axis A.

16. The method as described in claim 9, wherein the first sensor and the second sensor are three-axis accelerometers.
